(19) United States
(12) Patent Application Publication
(10) Pub. No.: US 2016/0370006 A1
(43) Pub. Date: Dec. 22, 2016

(54) CONNECTING STRUCTURE BETWEEN GAS ASSEMBLY AND GAS TRANSMISSION PIPELINE

(71) Applicant: NINGBO JINOU HARDWARE CO., LTD., Ningbo City (CN)

(72) Inventor: PAO-CHI Chang, NINGBO (CN)

(21) Appl. No.: 14/844,167

(22) Filed: Sep. 3, 2015

(30) Foreign Application Priority Data
Jun. 18, 2015 (TW) 104209912

(51) Int. Cl. F23Q 9/04; F24C 3/10; F16L 15/08

(52) U.S. Cl. CPC F23Q 9/04; F16L 15/08; F24C 3/10

(57) ABSTRACT

The present invention provides a connecting structure between gas assembly and gas transmission pipeline, comprising a gas transmission pipeline, a gas assembly and a gas assembly base. The gas transmission pipeline is for transmission of gas. The gas assembly is fixed on one end of the gas transmission pipeline, for configuration on a gas appliance. The gas assembly base is riveted on the outer side of one end of the gas assembly connecting the gas transmission pipeline, and abutted on a bulge loop preset on the outer side of the gas transmission pipeline; in this way, the gas transmission pipeline, gas assembly and gas assembly base can be fixed firmly together to avoid loosening or leakage.

### BACKGROUND OF INVENTION

1. Field of the Invention

The present invention is related to gas appliances, and more particularly to a connecting structure between gas assembly and gas transmission pipeline.

2. Description of Related Art A nozzle assembly used in a valve for conventional gas appliance pipelines generally comprises a nozzle, a nozzle base and an aluminum pipe. The nozzle is directly locked on the nozzle base of the valve, and the gas inlet pipeline is connected to the nozzle base. Gas flows through the gas inlet pipeline into the nozzle base, and flows out from the nozzle.

Either the joint between gas inlet pipeline and nozzle base, or the joint between nozzle base and nozzle may have loosening to cause gas leakage, and consequently shortened lifecycle and safety problem of the nozzle assembly. Secondly, in a conventional pilot fire structure integrating gas inlet pipeline, pilot fire and pilot, the gas inlet pipeline is connected to the pilot fire and gas tap, and the pilot fire and pilot are configured on one side of the gas stove. Danger of loosening and leakage may also happen between the gas inlet pipeline and the pilot fire.

Obviously, it is necessary to overcome the above shortcoming and enhance product lifecycle and safety.

### SUMMARY OF THE INVENTION

The main object of the present invention is to provide a connecting structure between gas assembly and gas transmission pipeline, which features simple construction and firm connection between gas assembly and gas inlet pipeline, and which can greatly reduce the possibility of leakage, maintain safe operation of the gas appliance, and reduce the manufacturing and assembly processes of the product components. Hence, the present invention has practical value.

Therefore, to realize the above object, the present invention provides a connecting structure between gas assembly and gas transmission pipeline, which includes a gas transmission pipeline, a gas assembly and a gas assembly base. The gas transmission pipeline is for transmission of gas, the gas assembly is fixed on one end of the gas transmission pipeline, for configuration on a gas appliance. The gas assembly base is riveted on the outer side of one end of the gas assembly connecting the gas transmission pipeline, and abutted on a bulge loop preset on the outer side of the gas transmission pipeline.

### BRIEF DESCRIPTION OF THE DRAWINGS

Below, examples of several preferred embodiments of the present invention and relevant drawings are provided for further detailed descriptions:

FIG. 1 is a sectional view of one preferred embodiment of the present invention.

FIG. 2 is a sectional view of another preferred embodiment of the present invention.

FIG. 3 is a sectional view of a further preferred embodiment of the present invention.

FIG. 4 is a sectional view of a further preferred embodiment of the present invention.

### DETAILED DESCRIPTION OF THE INVENTION

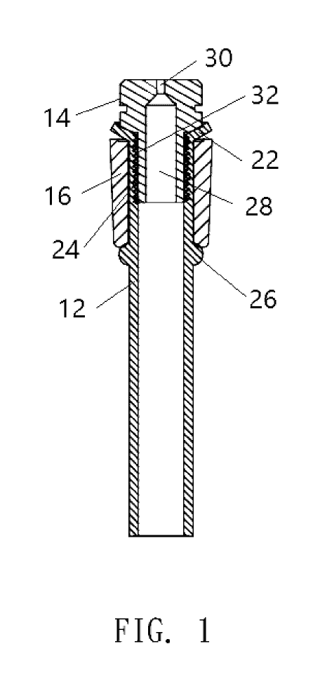

Firstly, referring to FIG. 1, one embodiment of the present invention of a connecting structure between gas assembly and gas transmission pipeline comprises a gas transmission pipeline 12, a gas assembly 14 and a gas assembly base 16.

The gas transmission pipeline 12 is for transmission of gas (for example, methane gas), and can be any kind of gas transmission pipeline used in conventional gas appliance (for example, gas tap) including aluminum pipe or copper pipe. One end is configured with a tilted external expansion portion 22, and the inner side is configured with an internal thread 24. And the outside periphery of the bottom of the external expansion portion 22 is configured with a bulge loop 26.

The gas assembly 14 is a nozzle used in conventional gas taps, comprising a gas inlet hole 28 and a gas outlet hole 30. The outer side of one end of the gas inlet hole 28 is configured with an external thread 32, which can be screwed with the internal thread 24, and fixed on one end of the gas transmission pipeline 12 for gas ejection.

The gas assembly base 16 is roughly in a ring shape, sleeved on the outer side of the screw joint end of the gas assembly 14 connecting the gas transmission pipeline 12, and tightly fitted between the external expansion portion 22 and the bulge loop 26.

To assemble the gas transmission pipeline 12, gas assembly 14 and gas assembly base 16, firstly sleeve the gas assembly base 16 on the outer side of the upper end of the gas transmission pipeline 12, above the bulge loop 26, and apply force on the upper side of the gas transmission pipeline 12 to form an external expansion portion 22, positioning the gas assembly base 16 between the external expansion portion 22 and the bulge loop 26, and then lock the gas assembly 14 on the upper end of the gas transmission pipeline 12. In this way, the gas assembly base 16 can be mounted inside a gas appliance, such as a valve.

From the above, it is known that the present invention of a connecting structure between gas assembly and gas transmission pipeline features a simple construction and can reduce the manufacturing and assembly processes of the product components. Moreover, the gas assembly and the gas transmission pipeline are integrally fixed together, and the gas assembly base is riveted on the outer side of the joint between the gas assembly and the gas transmission pipeline. Such a structure can avoid loosening during operation, and can greatly reduce the possibility of leakage and maintain safe operation of the gas appliance.

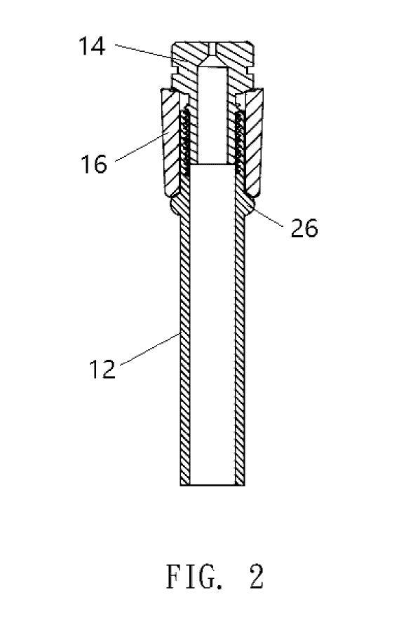

Of course, the upper side of the gas transmission pipeline 12 may not necessarily have configuration of an external expansion portion 22, and the gas assembly base 16 can be embedded between the gas assembly 14 and the bulge loop 26 to achieve the same efficacy to avoid loosening and leakage, as depicted in FIG. 2.

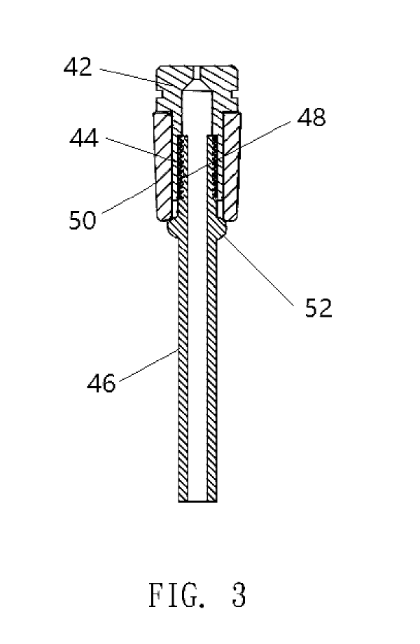

FIG. 3 depicts a further preferred embodiment of the present invention of a connecting structure between gas assembly and gas transmission pipeline. Its construction is roughly the same as the above embodiments. The difference lies in that: one end of the gas assembly 42 is configured with an internal thread 44, and one end of the gas transmission pipeline 46 is configured with an external thread 48 that can be screwed with the internal thread 44, and the gas assembly base 50 is tightly fitted between the gas assembly 42 and bulge loop 52, to press on the screw joint portion between the gas assembly 42 and gas transmission pipeline 46.

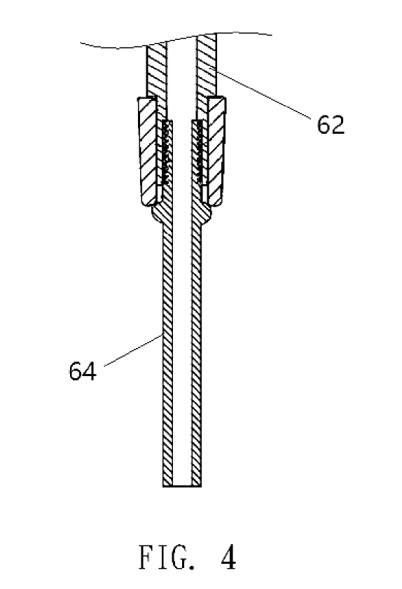

FIG. 4 depicts a further preferred embodiment of the present invention of a connecting structure between gas assembly and gas transmission pipeline. Its construction is roughly the same as the above embodiments. The difference lies in that: the gas assembly 62 is a pilot fire, and the gas transmission pipeline 64 is connected to the pilot fire gas outlet hole of the gas assembly 62 and gas tap, for gas output and ignition of the pilot fire to ignite the gas stove; such a construction can avoid risks of loosening and leakage between the gas inlet pipeline and pilot fire in conventional pilot fire structures integrating gas inlet pipeline, pilot fire and pilot.

It is to be noted that, the connection method between the gas assembly and gas transmission pipeline in the present invention is not limited to screw joint. Other joining methods like pressing joint or welding may also be applied.

What is claimed is:

1. A connecting structure between gas assembly and gas transmission pipeline, comprising a gas transmission pipeline, a gas assembly and a gas assembly base; the gas transmission pipeline is for transmission of gas; the gas assembly is fixed on one end of the gas transmission pipeline, for configuration on a gas appliance; the gas assembly base is roughly in a ring shape, sleeved on the outer side of the joint end between the gas assembly and gas transmission pipeline, and abutted on a bulge loop preset on the outer side of the gas transmission pipeline.

2. The structure defined in claim 1, wherein the gas assembly is screwed on one end of the gas transmission pipeline.

3. The structure defined in claim 2, wherein one end of the gas assembly is configured with an external thread, and one end of the gas transmission pipeline is configured with an internal thread that can be screwed with the external thread.

4. The structure defined in claim 2, wherein one end of the gas assembly is configured with an internal thread, and one end of the gas transmission pipeline is configured with an external thread that can be screwed with the internal thread.

5. The structure defined in claim 1, wherein the gas assembly base is tightly fitted between the gas assembly and the bulge loop.

6. The structure defined in claim 2, wherein the gas assembly base is tightly fitted between the gas assembly and the bulge loop.

7. The structure defined in claim 6, wherein one end of the gas transmission pipeline connecting the gas assembly is further configured with a tilted external expansion portion, the external expansion portion being located between the gas assembly and the gas assembly base.

8. The structure defined in claim 1, wherein the gas assembly is a nozzle, comprising a gas inlet hole and a gas outlet hole, the gas inlet hole being communicated with the gas transmission pipeline for the gas to be ejected from the gas outlet hole.

9. The structure defined in claim 1, wherein the gas assembly is a pilot fire igniter, the gas appliance is a gas stove, and the gas transmission pipeline is a pilot fire pipe, connecting the gas assembly to the pilot fire gas outlet hole of the gas tap, for gas output and ignition of the pilot fire to ignite the gas stove.
